(19) United States
(12) Patent Application Publication
(10) Pub. No.: US 2026/0320562 A1
(43) Pub. Date: Oct. 15, 2026

(54) INFORMATION PROCESSING DEVICE

(71) Applicant: TOYOTA JIDOSHA KABUSHIKI KAISHA, Toyota-shi (JP)

(72) Inventors: Aya YAMADA KAMISAKA, Tokyo (JP); Takayuki Yamabe, Tokyo (JP); Kota Hoshiba, Tokyo (JP); Ryota Nakanishi, Tokyo (JP); Hajime Tojiki, Tokyo (JP)

(73) Assignee: TOYOTA JIDOSHA KABUSHIKI KAISHA, Toyota-shi (JP)

(21) Appl. No.: 19/541,684

(22) Filed: Feb. 17, 2026

(30) Foreign Application Priority Data
Apr. 10, 2025 (JP) 2025-065182

(51) Int. Cl. G06Q 10/1093; G06Q 10/109

(52) U.S. Cl. CPC G06Q 10/1093; G06Q 10/109

(57) ABSTRACT

An information processing device configured to provide information to a user through a natural language dialogue service includes a control unit configured to: extract action information related to a planned action that is expected to be performed by the user with a probability exceeding a predetermined value among actions of the user; before a timing at which the planned action is expected to be performed, execute at least part of processing for generating, based on the action information, a response corresponding to a planned task related to the planned action, and store in a storage unit an execution result obtained by executing the at least part of the processing; and when a given task related to the planned task is requested by the user, generate a response corresponding to the given task by using the execution result stored in the storage unit, and output the generated response to the user.

### CROSS-REFERENCE TO RELATED APPLICATION

This application claims priority to Japanese Patent Application No. 2025-065182 filed on Apr. 10, 2025. The disclosure of the above-identified application, including the specification, drawings, and claims, is incorporated by reference herein in its entirety.

### BACKGROUND

### 1. Technical Field

The present disclosure relates to information processing devices.

### 2. Description of Related Art

When an agent provides information to a user, it performs processing such as information retrieval, information analysis, and response generation. The use of a high-performance engine for information analysis and response generation enables high-speed processing, but it tends to involve relatively high cost. For example, Japanese Unexamined Patent Application Publication No. 2016-9091 (JP 2016-9091 A) discloses a technique for generating a response text in view of a trade-off between response time and the reliability of the response content. In this technique, a response text from a high-speed, low-reliability engine is output first, and then a response text from a low-speed, high-reliability engine is output.

### SUMMARY

The method of the related art is not intended to reduce cost. Moreover, since a response text generated in response to a request is output twice, generation of the first response text may end up being wasted.

The present disclosure aims to balance response speed with processing cost when generating a response for providing information to a user, and to minimize the cost associated with generating the response.

One aspect of the present disclosure is an information processing device configured to provide information to a user through a natural language dialogue service. The information processing device includes a control unit configured to: extract action information related to a planned action that is expected to be performed by the user with a probability exceeding a predetermined value among actions of the user; before a timing at which the planned action is expected to be performed, execute at least part of processing for generating, based on the extracted action information, a response corresponding to a planned task related to the planned action, and store in a storage unit an execution result obtained by executing the at least part of the processing; and when a given task related to the planned task is requested by the user, generate a response corresponding to the given task by using the execution result stored in the storage unit, and output the response corresponding to the given task to the user.

Other aspects provide a method executed by the above information processing device, a program that causes a computer to execute the method, and a computer-readable storage medium that stores the program in a non-transitory manner.

The present disclosure can balance response speed with processing cost when generating a response for providing information to a user, and minimize the cost associated with generating the response.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an overview of an information provision system according to the present disclosure;

FIG. 2 shows a hardware configuration of an in-vehicle device;

FIG. 3 shows a software configuration of the in-vehicle device;

FIG. 4 is a first flowchart related to response processing for a task executed by the in-vehicle device;

FIG. 5 is a second flowchart related to response processing for a task executed by the in-vehicle device; and

FIG. 6 shows coordination among software modules of the in-vehicle device in response processing for a task.

### DETAILED DESCRIPTION OF EMBODIMENTS

In recent years, advances in machine learning have increased the number of products equipped with language models. For example, a natural-language dialogue function can be added to a target product by incorporating into the product a large language model (LLM) whose accuracy has been improved through machine learning using a large-scale dataset. One field in which dialogue in natural language is useful is automobiles. For example, by equipping an in-vehicle device with an LLM, it becomes possible to obtain information without operating a touch panel or the like. Such a function is particularly useful when the user's hands are occupied, such as while driving. For example, a natural-language dialogue function may be installed in embedded equipment in the vehicle (such as an in-vehicle device). However, in view of data size and cost, a configuration may be adopted in which the LLM is accessed via a network. Accessing the LLM via a network enables the use of a large-scale language model that is difficult to install in local storage.

With the improvement in such natural-language dialogue functions, it has become possible to provide various kinds of information to users. To achieve appropriate information provision to users, it is desired to smoothly respond to a user's request to execute a task, that is, to respond to the request as promptly as possible. On the other hand, achieving high-speed responses tends to increase the load on the device that performs information processing for providing information, which may lead to higher cost.

To achieve appropriate information provision to users, it is desired to respond as promptly as possible and minimize the associated cost. However, this issue has not been sufficiently addressed in conventional technologies. The information processing device according to the present disclosure addresses this issue.

The information processing device according to one aspect of the present disclosure is an information processing device configured to provide information to a user through a natural language dialogue service. The information processing device includes a control unit configured to: extract action information related to a planned action that is expected to be performed by the user with a probability exceeding a predetermined value among actions of the user; before a timing at which the planned action is expected to be performed, execute at least part of processing for generating, based on the action information, a response corresponding to a planned task related to the planned action, and store in a storage unit an execution result obtained by executing the at least part of the processing; and when a given task related to the planned task is requested by the user, generate a response corresponding to the given task by using the execution result stored in the storage unit, and output the response corresponding to the given task to the user.

Information may be provided to the user in various forms. For example, an external agent disposed outside the information processing device may be used. An external agent may be, for example, a system that can carry out dialogue in natural language and that provides a provision service using language models each specialized in a corresponding one of multiple domains (fields). The language models may be large language models (LLMs). A large language model is, for example, a language model trained such that it can execute dialogue tasks in natural language. Examples of the domains handled by such external agents include route directions, local information guidance, vehicle operation guidance, tourist guidance, and casual conversation. These external agents are typically configured to be remotely accessible via a network.

Alternatively, information may be provided to the user by using a local agent included in the information processing device. The language model included in the local agent is a language model capable of executing dialogue tasks in natural language, but unlike the external agents, may be a language model that has not been trained to be specialized in any specific domain and is generated at a relatively low cost.

The information processing device of the present disclosure may use either the external agent or the local agent. In either case, there is a trade-off between the speed of response to task requests and the cost for generating the response. Accordingly, for actions that are expected to be performed by the user with a relatively high probability (the planned action described above), the control unit of the information processing device performs predetermined pre-processing for responses to tasks related to such actions, in consideration of the high probability. Then, when a task request is actually received from the user, the result of the pre-processing is used to reduce the load associated with generating a response to the task, namely a response for providing information to the user. As a result, a balance is achieved between the response speed to the task and the associated cost, thereby implementing suitable information provision.

That is, for the pre-processing, the control unit extracts action information related to the user's planned action. The planned action is an action that the user is expected to perform from a probabilistic viewpoint. In such cases, the user is more likely to require various types of information regarding the planned action, and it can be said that there is a relatively high probability that the user will issue an information provision request to the information processing device, namely, a request for a planned task related to the planned action, or a task having some correlation with the planned task. Therefore, based on the extracted action information, the control unit performs predetermined pre-processing before the user actually makes a task request. The predetermined pre-processing is at least part of processing for generating a response corresponding to the planned task, and may be the processing for generating the response corresponding to the planned task. Alternatively, the at least part of the processing may be processing for retrieving and collecting information for generating the response corresponding to the planned task. The result of this pre-processing is stored in the storage unit and is used in subsequent information provision processing, that is, in generating a response when a task request is actually received from the user.

Here, the task actually requested by the user (the given task) may not coincide with the planned task used in the pre-processing. However, if the requested task is related to the planned task used in the pre-processing, it is considered possible to use the results obtained through the pre-processing (the execution result described above). In view of this, when a given task related to the planned task is requested, the control unit generates a response corresponding to the given task by using the execution result stored in the storage unit, and outputs the generated response to the user. Even when the actually requested given task coincides with the planned task used in the pre-processing, the control unit may similarly generate the response using the execution result. In this way, by performing processing for response generation in advance, the processing load when an actual task request is made can be reduced, thereby achieving a balance between response speed and processing cost and minimizing the cost associated with generating the response.

Hereinafter, specific embodiments of the present disclosure will be described with reference to the drawings. Unless otherwise specified, the hardware configurations, module configurations, and functional configurations described in the embodiments are not intended to limit the technical scope of the present disclosure to those configurations.

### First Embodiment

### System Overview

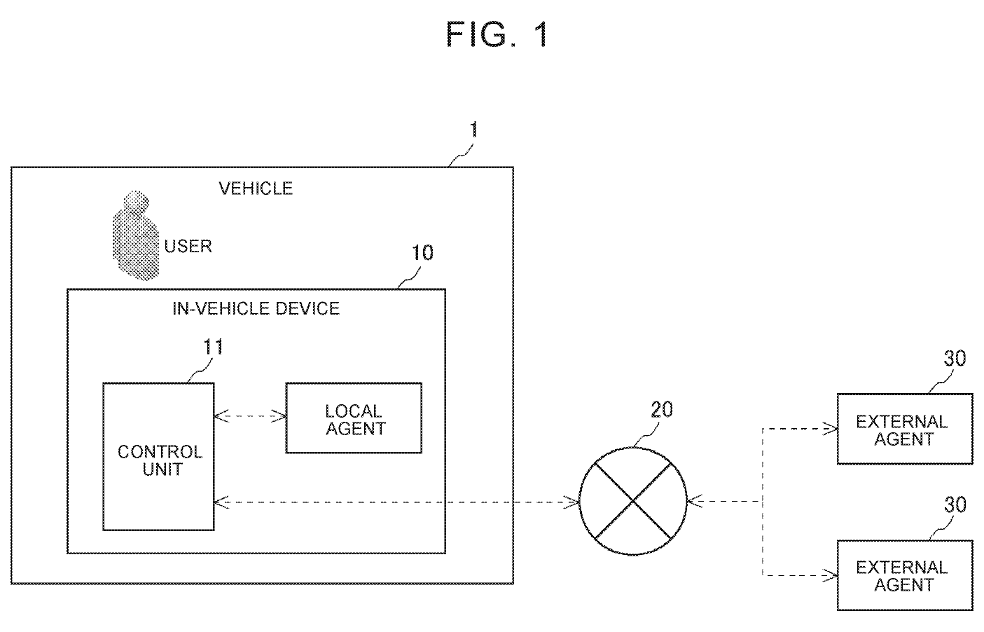

The general configuration of a provision system according to a first embodiment will be described with reference to FIG. 1. The provision system of the present embodiment includes an in-vehicle device 10 mounted in a vehicle 1. The in-vehicle device 10 can access an agent (external agent 30) that provides natural-language information provision services via a network 20 (e.g., a mobile communication network).

The in-vehicle device 10 is mounted in a connected vehicle that can communicate with various devices via wireless communication. The in-vehicle device 10 may include a data communication module (DCM) for connecting components of the vehicle 1 (e.g., electronic control units (ECUs) and in-vehicle terminals) to the network 20. In the present embodiment, the in-vehicle device 10 can access the Internet via the network 20 and connect to the external agent 30 that provides a provision service.

The vehicle 1 (or components installed in the vehicle 1) can provide various services by communicating with external devices via the in-vehicle device 10. Examples of such services include navigation services, remote control services (e.g., remote air conditioning), in-vehicle Wi-Fi (registered trademark) services, and emergency call services.

The in-vehicle device 10 further has a speech input/output function, and is capable of carrying out dialogue in natural language with occupants of the vehicle. The in-vehicle device 10 includes a control unit 11 that performs voice input and output and speech recognition, and a local agent. The local agent includes a language model trained to enable natural language dialogue. For example, the local agent may provide a predetermined function such as route search or vehicle operations (e.g., air conditioning) through dialogue. The local agent is also configured to provide natural-language information provision services in the same manner as the external agent 30. The language model used by the local agent is stored in a storage device included in the in-vehicle device 10.

The size of the language model used for information provision services using natural language dialogue varies greatly depending on its functions. For example, there is a wide variety of dialogue categories, including local information, tourist guidance, vehicle-related information (operation manuals), and casual conversation, and in order to cover all of these categories, preparing a language model trained using a large-scale dataset is necessary. Such a language model can range in size from several gigabytes to several hundred gigabytes, which makes it difficult to install it in the in-vehicle device 10 having limited storage capacity. Accordingly, an information service function using a large-scale language model is assigned to the external agent 30. The in-vehicle device 10 is equipped with a relatively small-scale language model, and the local agent uses this relatively small-scale language model to provide a natural-language information provision service in response to requests from a limited number of users.

In the description of the present embodiment, expressions such as "access an external agent" and "connect to an external agent" refer to accessing or connecting to an external device that provides a provision service via the external agent. In the present embodiment, each of a plurality of provision services using large-scale language models is running as an "external agent" on a corresponding one of a plurality of external devices, and the in-vehicle device 10 can carry out dialogue by connecting to any of these external agents.

### Hardware Configuration

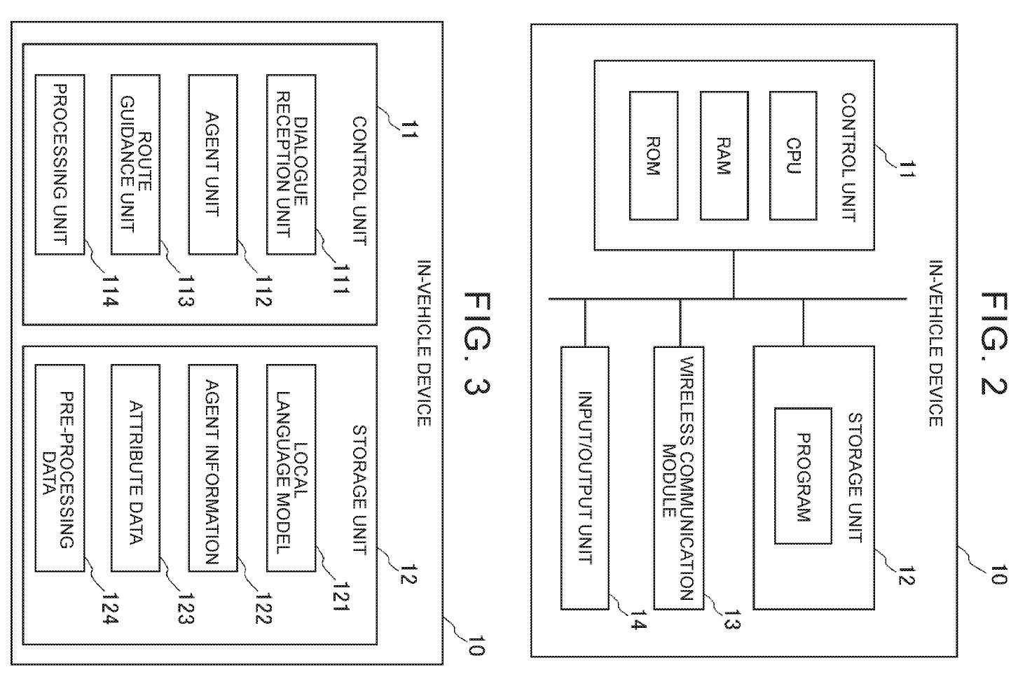

Next, the hardware configuration of the devices constituting the provision system will be described. FIG. 2 schematically shows an example of the hardware configuration of the in-vehicle device 10 according to the present embodiment.

The in-vehicle device 10 can be configured as a computer that includes a processor (a central processing unit (CPU), a graphics processing unit (GPU), etc.), a main storage device (random access memory (RAM), read-only memory (ROM), etc.), and an auxiliary storage device (erasable programmable read-only memory (EPROM), hard disk drive, removable medium, etc.). The auxiliary storage device stores an operating system (OS), various programs, various tables, etc. Various functions (software modules) for predetermined purposes, as described later, can be implemented by executing the programs stored in the auxiliary storage device. However, part or all of the functions may alternatively be implemented as hardware modules by using hardware circuits such as application-specific integrated circuits (ASICs) or field-programmable gate arrays (FPGAs).

The in-vehicle device 10 includes, as hardware components, a control unit 11, a storage unit 12, a wireless communication module 13, and an input/output unit 14.

The control unit 11 is a computing unit that implements various functions of the in-vehicle device 10 by executing predetermined programs. The control unit 11 can be implemented by, for example, a hardware processor such as a CPU. The control unit 11 may include RAM, ROM, and cache memory.

The storage unit 12 serves as means for storing information and is constituted by a storage medium such as RAM, magnetic disk, or flash memory. The storage unit 12 stores programs executed by the control unit 11 and data used by the programs.

The wireless communication module 13 is a communication device that performs wireless communication with a predetermined network. In the present embodiment, the wireless communication module 13 is configured to communicate with the network 20 that is a mobile communication network. The wireless communication module 13 may include an embedded Universal Integrated Circuit Card (eUICC) (e.g., a Subscriber Identity Module (SIM) card). The SIM card is configured as a microcomputer that includes a CPU and a storage device. The SIM card stores information for connecting to the network 20 and receiving authentication.

The input/output unit 14 is a unit that receives input from a user of the device and presents information to the user. The input/output unit 14 typically includes devices that input and output audio, such as a microphone and a speaker. The input/output unit 14 may also include a device that provides visual information (display, etc.).

### Software Configuration

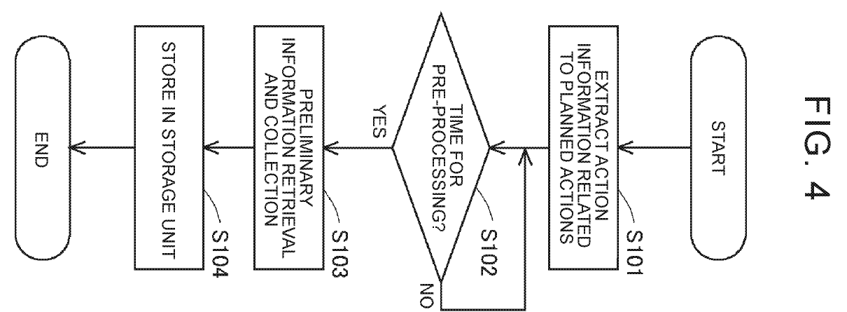

Next, the software configuration of the devices constituting the system will be described. FIG. 3 schematically shows the software configuration of the in-vehicle device 10 according to the present embodiment. In the present embodiment, the control unit 11 of the in-vehicle device 10 includes four software modules: a dialogue reception unit 111, an agent unit 112, a route guidance unit 113, and a processing unit 114. Each software module may be implemented by the control unit 11 (e.g., the CPU) executing a program stored in the storage unit 12. The information processing executed by the software modules is equivalent to the information processing executed by the control unit 11 (e.g., the CPU).

The dialogue reception unit 111 acquires an utterance made by a vehicle occupant (hereinafter also referred to as "user") via the input/output unit 14. The dialogue reception unit 111 executes predetermined processing on the acquired audio data and executes speech recognition. The content of the utterance is thus converted into text. The dialogue reception unit 111 then transmits the text obtained as a result of the speech recognition to the agent unit 112. The dialogue reception unit 111 also outputs, as audio or on a display, the response (hereinafter referred to as "response text") sent from the agent unit 112.

The agent unit 112 provides an information provision service. Specifically, the agent unit 112 provides an information provision service using a language model stored in the own device (a local language model 121, which will be described later). The agent unit 112 can behave as a virtual agent (local agent). The local agent can provide, for example, a provision service that can be completed within the own device (e.g., casual conversations). When the dialogue involves specialized knowledge, the agent unit 112 sends the utterance text to one or more external agents 30 available via the network 20, obtains the result, and provides it to the user, thereby implementing an information provision service. For example, when determination is made that the user is seeking information about the vehicle 1, the agent unit 112 selects an external agent 30 capable of providing operation guidance for the vehicle 1. When determination is made that the user is seeking information about facilities or shops, the agent unit 112 selects an external agent 30 capable of providing such information. The selection of the external agent 30 may be made based on the result of analyzing the content of the utterance. For example, the agent unit 112 may calculate a relevance score for each of the external agents 30 based on words or context contained in the utterance, and send the utterance text to an external agent 30 whose relevance score is greater than or equal to a predetermined value.

Furthermore, the agent unit 112 uses the results of the pre-processing executed by the processing unit 114, described later, to generate a response corresponding to a given task requested by the user. This response generation will be described in detail later.

The route guidance unit 113 receives a departure point and destination specified by the user, or receives a command from the agent unit 112 (e.g., a command to set location information of a destination recommended to the user), and generates a route connecting the departure point and the destination based on road map data etc. The route guidance unit 113 also outputs information about the generated route via the input/output unit 14.

The processing unit 114 executes at least part of the processing for generating a response corresponding to a planned task related to a planned action, namely an action that the user is expected to perform with a probability exceeding a predetermined value among the actions the user may take. The predetermined probability serves as a threshold for identifying planned actions that are to be pre-processed by the processing unit 114, and may be set in consideration of factors such as the processing load associated with the processing unit 114. The pre-processing executed by the processing unit 114 refers to processing that is executed prior to the agent unit 112 generating a response corresponding to an actual given task from the user, and that is executed to generate data that may be used for that response generation.

Examples of such planned actions include actions that the user performs with a relatively high frequency, and actions that the user is highly likely to perform as part of a future schedule, that is, actions that the user is expected to perform with a probability exceeding the predetermined value. More specifically, examples of the actions that the user performs with a relatively high frequency include actions that the user has performed more often than a predetermined frequency in the user's past behavior history. The processing unit 114 can extract action information related to a planned action based on information on the user's behavior history included in attribute data 123 described later. Examples of the actions that the user is highly likely to perform as part of a future schedule include actions included in the user's schedule information. The processing unit 114 can extract, as action information related to a planned action, information related to the user's actions included in the user's schedule information in the attribute data 123.

The processing unit 114 then executes at least part of the processing for generating a response corresponding to a planned task related to the planned action. A planned task is a task that would be requested by the user if the user were to perform the planned action. The planned task may be derived by using the local agent included in the in-vehicle device 10, or may be derived through rule-based processing. "At least part of the processing" executed by the processing unit 114 refers to part or all of the processing for generating a response corresponding to the planned task via the agent unit 112. For example, at least part of the processing may include processing for searching for and collecting information used for generating the response, or may be the response generation processing itself based on the collected information.

The execution results of at least part of the processing, as executed by the processing unit 114, are stored in the storage unit 12. The stored execution results constitute pre-processing data 124 described later. The processing executed by the processing unit 114 will be described in detail later.

The storage unit 12 included in the in-vehicle device 10 stores a local language model 121, agent information 122, the attribute data 123, and the pre-processing data 124. The local language model 121 is a language model trained such that it can execute dialogue tasks in natural language. The local language model 121 is a language model that is generated at relatively low cost, and may be, for example, a language model for general-purpose conversational use. The local language model 121 is a lightweight language model compared to the large-scale language models used by the external agents accessible via the network. It is thus possible to selectively use external and local agents. For example, when a conversation involves specialized knowledge, the utterance text is sent to an external agent, whereas utterances in conversations where a quick response is desired can be handled by the local agent.

The agent information 122 is a collection of data related to multiple external agents that are available to the in-vehicle device 10. The agent information 122 may include, for example, identifiers and names of the external agents, information regarding the domains in which the external agents specialize, and information regarding their access destinations (such as network addresses of the external devices that provide the external agents). By referring to the agent information 122, the agent unit 112 can determine the external agent to which the utterance text is to be sent.

The attribute data 123 is a collection of data related to attributes of the user who interacts with the in-vehicle device 10. The attribute data 123 may include, for example, personal information such as the user's gender, age, height, and weight. The attribute data 123 may further include information regarding the user's family structure. The attribute data 123 may further include information regarding the user's past behavior history and schedule information. The past behavior history may be accumulated in the attribute data based on task requests made by the user and the corresponding responses provided via the dialogue reception unit 111 in the in-vehicle device 10. Alternatively, the in-vehicle device 10 may access an external server or a mobile terminal (such as a smartphone owned by the user) in which the user's behavior history is stored, obtain behavior history information from the external server or the mobile terminal, and store it in the attribute data. Regarding schedule information, the in-vehicle device 10 may access an external server or a mobile terminal (such as a smartphone owned by the user) in which the user's schedule information is stored, obtain the schedule information from the external server or the mobile terminal, and store it in the attribute data. When there are multiple users of the vehicle, the attribute data 123 may also include data for each of the users.

The pre-processing data 124 is data related to the execution results of at least part of the processing as executed by the processing unit 114 as described above. Accordingly, the pre-processing data 124 is updated as appropriate in accordance with the pre-processing executed by the processing unit 114.

### Flow of Providing Information to User

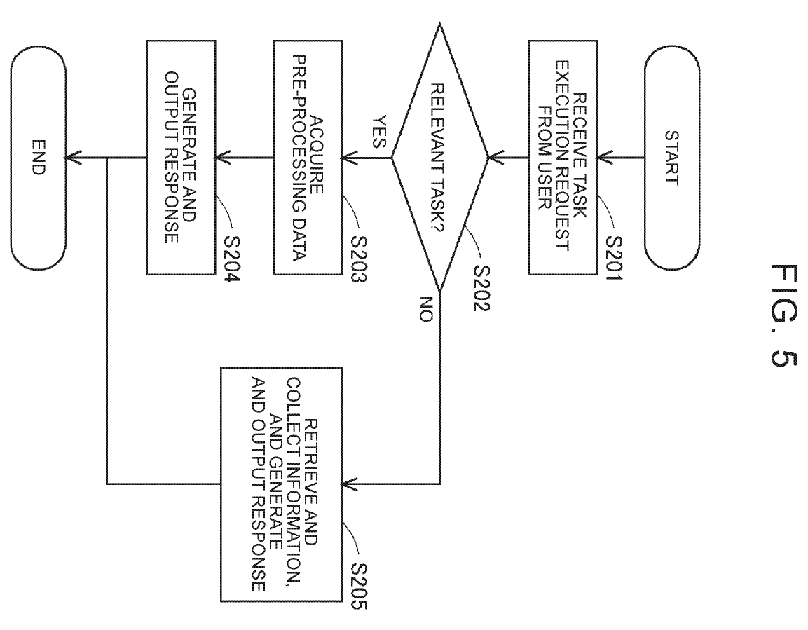

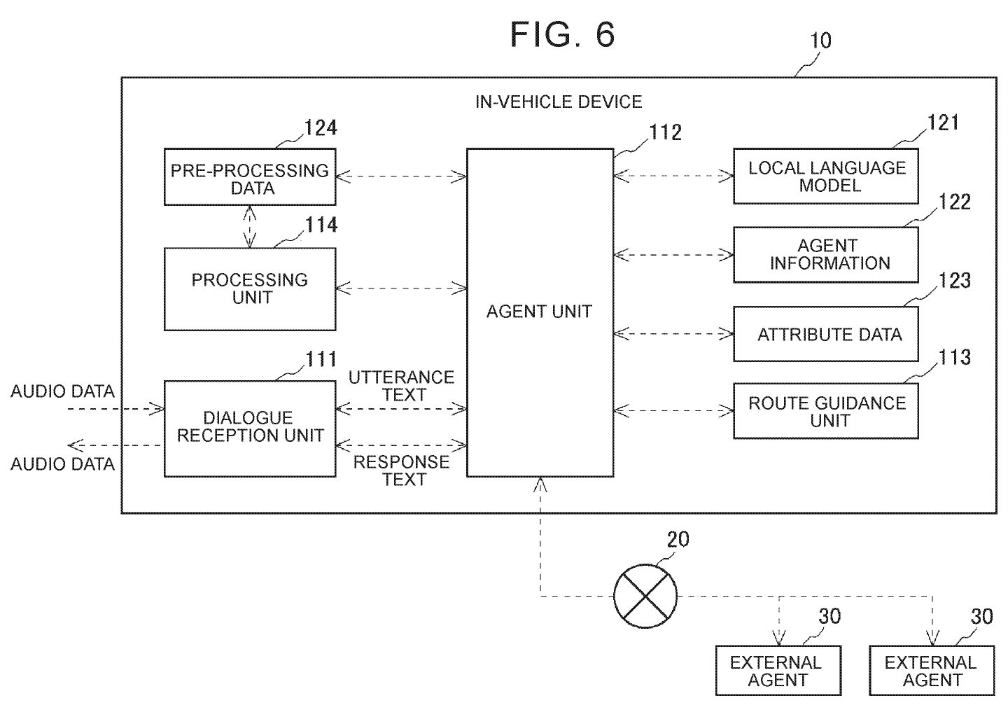

FIG. 4 is a flowchart showing the flow of the first stage of the process for providing information to the user. The processing in the first stage mainly corresponds to the pre-processing executed by the processing unit 114. FIG. 5 is a flowchart showing the flow of the second stage of the process for providing information to the user. The processing in the second stage mainly corresponds to the response generation processing executed by the agent unit 112. FIG. 6 shows the coordination among the software modules of the control unit 11 of the in-vehicle device 10 during these processing flows. The processing flow executed by the control unit 11 will be described below with reference to these figures.

First, the processing flow shown in FIG. 4 will be described. This process may be executed each time the attribute data 123, which is user information, is updated, or may be repeatedly executed at predetermined intervals. In step S101, the processing unit 114 extracts action information related to the user's planned actions. Planned actions may be actions that the user has performed more often than a predetermined frequency in the user's past behavior history. For example, if the user's behavior history indicates that the user checks the news in the 7 a.m. hour more often than a predetermined frequency, "checking the news in the 7 a.m. hour" can be a planned action. The processing unit 114 can extract action information related to such planned actions based on the user's behavior history information contained in the attribute data 123. Alternatively, planned actions may be actions contained in the user's schedule information. In particular, actions such as family-related activities (e.g., a family birthday party or a family trip) or business-related engagements (e.g., a business trip or dining with a business partner) can be regarded as more important planned actions for the user. For example, if a "family birthday party" is planned according to the user's schedule information, the "family birthday party" can be a planned action. The processing unit 114 can extract, based on the user's schedule information contained in the attribute data 123, information regarding the user's actions included in the schedule information as action information related to planned actions. After step S101 is completed, the process proceeds to step S102.

In step S102, it is determined whether it is time to execute the pre-processing by the processing unit 114. As described above, a planned action is an action that the user is expected to perform with a probability exceeding a predetermined value, the timing at which it may be performed can be anticipated. For example, for the planned action of "checking the news in the 7 a.m. hour," the execution timing would be the 7 a.m. hour, and for the planned action of "a family birthday party," the execution timing would be the date and time at which the birthday party is scheduled to take place. If the pre-processing by the processing unit 114 is executed too early, information may be retrieved and collected at a timing that is too far from the execution timing of the planned action, and from the standpoint of generating data to be used for producing a response to the user's task request, this processing may not be regarded as appropriate pre-processing. Accordingly, the determination in step S102 is performed to determine whether the appropriate timing for the pre-processing has arrived. The timing for executing the pre-processing may be determined according to the content of the planned action. For example, when the planned action is one that may be performed on a daily basis, the timing for executing the pre-processing may be, for example, one hour before the planned action. When the planned action is one is performed once a year, the timing for executing the pre-processing may be, for example, one week before the planned action. When an affirmative determination is made in step S102, the process proceeds to step S103. When a negative determination is made in step S102, step S102 is repeated.

In step S103, since the timing for executing the pre-processing has arrived, the processing unit 114 executes, via the agent unit 112, the pre-processing for generating data that may be used for generating a response to a future given task from the user, that is, information retrieval and information collection performed in preparation for the user's future given task. Specifically, on the premise that the planned action has some relevance to a future given task from the user, processing related to the generation of a response corresponding to a planned task associated with the user's planned action is performed in S103 based on the extracted action information. For example, when the user's planned action is "checking the news in the 7 a.m. hour," the planned task may be "collecting information on politics and economy in Japan" as determined in view of the user's attributes such as occupation. Alternatively, when the user's planned action is "a family birthday party," the planned task may be "searching for gift candidates for the child" as determined in view of the user's attributes such as family structure.

At the time of the processing in step S103, the user's future given task cannot be accurately predicted. Therefore, processing for preparing for the future given task is executed in step S103 by using the action information related to the planned action. Specifically, the processing unit 114 passes the planned task to the agent unit 112 and acquires the response to the planned task as the execution result of the pre-processing. Upon receiving the planned task, the agent unit 112 identifies its content, acquires the agent information 122 regarding the external agents from the storage unit 12, and, by using the agent information 122, determines the external agent 30 to which the planned task is to be sent. The content of the planned task may be determined using the local language model 121, or may be determined using another machine learning model. The content of the planned task may alternatively be determined by rule-based processing. The agent unit 112 may also determine that it is not necessary to send the planned task to an external agent. In such a case, the planned task may be processed by the agent unit 112 (and the local language model 121). Subsequently, in step S104, the processing unit 114 stores the acquired execution result in the storage unit 12 as the pre-processing data 124.

The above describes the processing flow shown in FIG. 4.

Next, the processing flow shown in FIG. 5 will be described. This processing is executed, for example, when the user issues a request for a given task. In step S201, a request to execute a given task related to information provision is received from the user riding in the vehicle 1. This processing is executed by the dialogue reception unit 111. Specifically, the dialogue reception unit 111 acquires an utterance related to the request from the user through the input/output unit 14. For example, the input/output unit 14 converts the utterance acquired through a microphone or the like into audio data, and the dialogue reception unit 111 acquires the audio data. The dialogue reception unit 111 executes predetermined speech recognition processing on the acquired audio data and converts the audio data into text. The dialogue reception unit 111, while withholding a response to the utterance, sends the text obtained through the speech recognition to the agent unit 112. This text is referred to as "utterance text."

In step S202, it is determined whether the given task received in step S201 is a task relevant to the planned task corresponding to the pre-processing data 124. In other words, it is determined whether the pre-processing data 124 can be used in generating a response to the given task. Specifically, the agent unit 112 may calculate a relevance score between the given task and the planned task, and an affirmative determination may be made in step S202 when the relevance score is greater than or equal to a predetermined value. When an affirmative determination is made in step S202, the process proceeds to step S203. When a negative determination is made in step S202, the process proceeds to step S205.

In response to an affirmative determination in step S202, the agent unit 112 acquires the pre-processing data 124 in step S203. Thereafter, in step S204, the agent unit 112 generates a response to the given task from the user by using the pre-processing data 124. Specifically, the agent unit 112 executes information provision processing based on the utterance text related to the given task, sent by the dialogue reception unit 111, and the pre-processing data. More specifically, upon receiving the utterance text and the pre-processing data, the agent unit 112 may generate the response to the given task by using the same agent as the external agent that executed the processing related to the planned task (i.e., the processing in step S103). The generated response is sent to the agent unit 112 as a response text, and the agent unit 112 outputs the response to the user as a response to the given task, through the dialogue reception unit 111 (i.e., provides the information). Specifically, the dialogue reception unit 111 generates audio data based on the response text and outputs the audio data through the input/output unit 14. The dialogue reception unit 111 may generate the audio data for reading out the response text or may generate information accompanying the audio data. Examples of the information accompanying the audio data include a user interface screen. The user interface screen may include the response text in text form.

In the response generation in step S204, the pre-processing data (information collected for the planned task) is used. Therefore, in step S204, there is no need to collect the information contained in the response. This significantly reduces the processing load associated with generating the response. In other words, the processing for generating the response to the user's given task can be distributed between the processing in the first stage shown in FIG. 4 and the processing in the second stage shown in FIG. 5. This reduces the load associated with generating responses to given tasks and enables relatively quick responses to be provided to the user, while keeping the required performance of the large language model (LLM) mounted in the external agent 30 and the local language model 121 at a low level. That is, this makes it possible to balance response speed with processing cost and to minimize the cost associated with response generation.

In response to a negative determination in step S202, the agent unit 112 generates a response to the given task from the user in step S205. In this case, the pre-processing data 124 is not used. The agent unit 112 performs information retrieval and information collection for generating the response to the given task. Thereafter, the agent unit 112 generates the response using the collected information and outputs the response to the user. The output to the user is as described above. When the processing in step S205 is executed, the processing for generating the response is not distributed, and therefore the processing load is not reduced.

As described above, the processing shown in FIGS. 4 and 5 can balance response speed with processing cost when generating a response for providing information to the user, and minimize the cost associated with generating the response.

In step S204 shown in FIG. 5, the response generation is performed using the pre-processing data 124. However, the response generation may alternatively be performed by executing additional information retrieval and information collection for generating the response corresponding to the given task, and generating the response using both the pre-processing data 124 and the additional information. Such additional information collection can make the content of the response output to the user more appropriate. However, in view of the purpose of generating the pre-processing data 124, it is undesirable for the processing load associated with such additional information collection to become large. Therefore, when performing additional information collection, the range of information to be collected may be limited in order to reduce the processing load. For example, the

processing such as the information collection may be executed on new information that has arisen during the period after the timing at which the pre-processing was executed (i.e., after the processing of steps S103 and S104 was executed).

### Modifications

The embodiments described above are merely examples, and the present disclosure can be modified as appropriate without departing from the spirit and scope of the disclosure. For example, the processes and means described in the present disclosure may be combined as desired as long as no technical inconsistencies arise. In a modification of the present disclosure, the information processing device of the present disclosure may be configured as a server device installed in a stationary manner rather than as an in-vehicle device mounted in a vehicle.

The above embodiments illustrate an example in which external agents are deployed on external devices connected to the Internet. However, the external agents may instead be deployed on other types of devices. For example, the external agents may be deployed on an edge server accessible from the vehicle. The external agents may alternatively be distributed across a plurality of edge servers or cloud systems. Although the embodiments illustrate the in-vehicle device 10 as the information processing device according to the present disclosure, the information processing device may alternatively be implemented as a device or equipment that is not mounted in a vehicle.

When the external agents are deployed across multiple edge servers or the like, the in-vehicle device 10 may acquire the location information of its own vehicle and identify, based on the location information, the edge server on which the desired external agent is deployed. For example, there may be cases where external agents that provide local information may be respectively deployed on multiple edge servers each located in a different area. In such a case, the in-vehicle device 10 may identify the external agent deployed on the geographically closest edge server based on the location information of the vehicle. The local information handled by the external agents may differ from one edge server to another. For example, an external agent that provides local information for area A may be deployed on an edge server located in area A, and an external agent that provides local information for area B may be deployed on an edge server located in area B. The in-vehicle device 10 can obtain local information for the area in which the own vehicle is located by identifying the edge server corresponding to that area and accessing the external agent provided by that edge server.

The processing described as being executed by a single device may be divided among multiple devices. The processing described as being executed by different devices may be executed by a single device. In a computer system, the hardware configuration (server configuration) used to implement each function can be flexibly modified.

The present disclosure can also be implemented by supplying a computer with a computer program that implements the functions described in the above embodiment, and causing one or more processors of the computer to read and execute the program. Such a computer program may be provided to the computer via a non-transitory computer-readable storage medium connectable to a system bus of the computer, or may be provided to the computer via a network. Examples of the non-transitory computer-readable storage medium may include any type of disk such as a magnetic disk (floppy (registered trademark) disk, hard disk drive (HDD), etc.), an optical disc (compact disc read-only memory (CD-ROM), digital versatile disc (DVD), Blu-ray disc, etc.), read-only memory (ROM), random access memory (RAM), erasable programmable read-only memory (EPROM), electrically erasable programmable read-only memory (EEPROM), a magnetic card, flash memory, an optical card, and any other type of medium suitable for storing electronic instructions.

What is claimed is:

1. An information processing device configured to provide information to a user through a natural language dialogue service, the information processing device comprising a control unit configured to
extract action information related to a planned action that is expected to be performed by the user with a probability exceeding a predetermined value among actions of the user,
before a timing at which the planned action is expected to be performed, execute at least part of processing for generating, based on the extracted action information, a response corresponding to a planned task related to the planned action, and store in a storage unit an execution result obtained by executing the at least part of the processing, and
when a given task related to the planned task is requested by the user, generate a response corresponding to the given task by using the execution result stored in the storage unit, and output the response corresponding to the given task to the user.

2. The information processing device according to claim 1, wherein the control unit is configured to extract, as the action information, information related to an action that the user has performed more often than a predetermined frequency in a past behavior history of the user.

3. The information processing device according to claim 1, wherein the control unit is configured to extract, as the action information, information related to an action of the user included in schedule information of the user.

4. The information processing device according to claim 1, wherein the control unit is configured to execute, as the at least part of the processing, at least collecting, based on the extracted action information, information for generating the response corresponding to the planned task, and store the collected information in the storage unit as the execution result.

5. The information processing device according to claim 4, wherein the control unit is configured to, when the given task is requested by the user, collect additional information for generating the response corresponding to the given task, generate the response corresponding to the given task using the execution result stored in the storage unit and the additional information, and output the response corresponding to the given task to the user.
